(19) United States
(12) Patent Application Publication
(10) Pub. No.: US 2026/0039357 A1
(43) Pub. Date: Feb. 5, 2026

(54) Methods on Dynamic Constellations and MCS Tables

(71) Applicant: InterDigital Patent Holdings, Inc., Wilmington, DE (US)

(72) Inventors: Ahmet Serdar Tan, London (GB); Yugeswar Deenoo Narayanan Thangaraj, Chalfont, PA (US); Anouar Yatribi, London (GB); Mihaela Beluri, Jericho, NY (US)

(73) Assignee: InterDigital Patent Holdings, Inc., Wilmington, DE (US)

(21) Appl. No.: 18/794,277

(22) Filed: Aug. 5, 2024

(51) Int. Cl. H04B 7/06; H04B 17/309; H04W 72/23

(52) U.S. Cl. CPC H04B 7/0632; H04B 17/346; H04W 72/23

(57) ABSTRACT

A wireless transmit/receive unit (WTRU) comprises a processor configured to receive configuration information that may include an indication of a first Channel Quality Indicator (CQI) table associated with preconfigured modulations. The configuration information may include an indication of a second CQI table associated with learned modulations. The processor may determine first measurements associated with a plurality of reference signals (RSs) of a first type that may be associated with the preconfigured modulations. The processor may determine second measurements associated with a plurality of RSs of a second type that may be associated with the learned modulations. The processor may determine to use the second CQI table instead of the first CQI table based on a comparison between the second measurements associated with the plurality of RSs of the second type with the first measurements associated with the plurality of RSs of the first type. The processor may send a report.

### BACKGROUND

Symbol modulation and symbol demodulation are among the fundamental blocks of the physical (PHY) layer of wireless communications. Symbol modulators convert a group of bits to complex symbols that represent the in-phase and quadrature components of the baseband signal, whereas symbol demodulators convert the received baseband complex signals to group of bits that are fed into the channel decoder. The number of bits carried within a symbol depends on the modulation order of the modulation scheme. Legacy symbol modulation schemes include QPSK, 16-QAM, 64-QAM, 256-QAM, etc. where constellation shapes are grid based. In the current specifications, constellations per modulation order and corresponding Modulation and Coding Scheme (MCS) tables are pre-defined.

Learned constellations (e.g., through techniques like end-to-end learning with autoencoders) may improve the bit error rate and/or throughput performance. An example learned constellation shape for modulation order 4 (i.e., 4 bits per symbol) under non-linear phase noise is given in FIGS. 2A and 2B, where the received symbols are also illustrated. The end-to-end learning schemes may dynamically learn the mapper (bits to symbols) and de-mapper (received symbols to bits). In the current specifications, procedures to handle learned constellations (e.g., dynamic MCS tables, mapper, de-mapper) are not defined.

### SUMMARY

A wireless transmit/receive unit (WTRU) may comprise a processor. The processor may be configured to receive configuration information. The configuration information may include, for example, an indication of a first Channel Quality Indicator (CQI) table associated with preconfigured modulations (e.g., preconfigured modulation and coding schemes). The configuration information may include, for example, an indication of a second CQI table associated with learned modulations (e.g., learned modulation and coding schemes). The processor may be configured to determine first measurements associated with a plurality of reference signals (RSs) of a first type. The first type of RSs may be associated with the preconfigured modulations. The processor may be configured to determine second measurements associated with a plurality of RSs of a second type. The second type of RSs may be associated with the learned modulations. The processor may be configured to determine to use the second CQI table instead of the first CQI table based on a comparison between the second measurements associated with the plurality of RSs of the second type with the first measurements associated with the plurality of RSs of the first type. The processor may be configured to send a report. The report may include, for example, CQI and an indication that the second CQI table type was used to determine the CQI.

The first measurements may include, for example, a first signal-to-noise ratio (SNR). The second measurements may include, for example, a second SNR. The processor may be configured to determine to use the second CQI table to determine the CQI based on the second SNR being greater than the first SNR.

The first measurements may include, for example, a first Mean Square Error (MSE). The second measurements may include, for example, a second MSE. The processor may be configured to determine to use the second CQI table to determine the CQI based on the second MSE being less than the first MSE.

The first measurements may be associated with one or more of a first throughput, a first Block Error Ratio (BLER), or a first number of retransmissions. The second measurements may be associated with one or more of a second throughput, a second Block Error Ratio (BLER), or a second number of retransmissions.

The report may include, for example, assistance information for fallback to the first CQI table type. The assistance information may include, for example, an SNR offset or a CQI index.

The configuration information may include, for example, an indication of a first Modulation and Coding Scheme (MCS) table associated with preconfigured modulations, an indication of a second MCS table associated with the learned modulations, and/or a symbol-to-bits de-mapper associated with the second MCS table. The processor may be configured to receive Downlink Control Information (DCI) that provides a Physical Downlink Shared Channel Transmission (PDSCH) allocation. The processor may be configured to receive a PDSCH transmission associated with the PDSCH allocation. The processor may be configured to demodulate the PDSCH transmission using the symbol-to-bits de-mapper associated with the second MCS table. The processor may be configured to decode the PDSCH transmission based on the second MCS table.

The DCI may indicate that the second MCS table should be used to demodulate the PDSCH allocation.

The processor may be configured to determine to use the second CQI table instead of the first CQI table to determine the CQI when the second MCS table is signaled.

The configuration information may include, for example, CQI assistance information that provides a mapping of values between the first CQI table and the second CQI table.

The learned modulations may be based on an artificial intelligence/machine learning (AI/ML) model. The learned modulations may be characterized by a non-equal distance between constellations of each modulation order of the learned modulation orders. The preconfigured modulation orders may include, for example, one or more of Binary Phase-shift keying (BPSK), Quadrature Phase Shift Keying (QPSK), or 16-Quadrature amplitude modulation (QAM). The preconfigured modulation orders may be characterized by an equidistance between constellations of each modulation order of the preconfigured modulation orders.

A WTRU may be configured to perform a method that includes one or more of the following steps. The method may include receiving configuration information. The configuration information may include, for example, an indication of a first Channel Quality Indicator (CQI) table associated with preconfigured modulations. The configuration information may include, for example, an indication of a second CQI table associated with learned modulations. The method may include determining first measurements associated with a plurality of reference signals (RSs) of a first type. The first type of RSs may be associated with the preconfigured modulations. The method may include determining second measurements associated with a plurality of RSs of a second type. The second type of RSs may be associated with the learned modulations. The method may include determining to use the second CQI table instead of the first CQI table based on a comparison between the second measurements associated with the plurality of RSs of the second type with the first measurements associated with the plurality of RSs of the first type. The method may include sending a report. The report may include, for example, CQI and an indication that the second CQI table type was used to determine the CQI.

The first measurements may include, for example, a first signal-to-noise ratio (SNR). The second measurements may include, for example, a second SNR. The method may include determining to use the second CQI table to determine the CQI based on the second SNR being greater than the first SNR.

The first measurements may include, for example, a first Mean Square Error (MSE). The second measurements may include, for example, a second MSE. The method may include determining to use the second CQI table to determine the CQI based on the second MSE being less than the first MSE.

The first measurements may be associated with one or more of a first throughput, a first Block Error Ratio (BLER), or a first number of retransmissions. The second measurements may be associated with one or more of a second throughput, a second Block Error Ratio (BLER), or a second number of retransmissions.

The report may include, for example, assistance information for fallback to the first CQI table type. The assistance information may include, for example, an SNR offset or a CQI index.

The configuration information may include, for example, an indication of a first Modulation and Coding Scheme (MCS) table associated with preconfigured modulations, an indication of a second MCS table associated with the learned modulations, and/or a symbol-to-bits de-mapper associated with the second MCS table. The method may include receiving Downlink Control Information (DCI) that provides a Physical Downlink Shared Channel Transmission (PDSCH) allocation. The method may include receiving a PDSCH transmission associated with the PDSCH allocation. The method may include demodulating the PDSCH transmission using the symbol-to-bits de-mapper associated with the second MCS table. The method may include decoding the PDSCH transmission based on the second MCS table.

The DCI may indicate that the second MCS table should be used to demodulate the PDSCH allocation.

The method may include determining to use the second CQI table instead of the first CQI table to determine the CQI when the second MCS table is signaled.

The configuration information may include, for example, CQI assistance information that provides a mapping of values between the first CQI table and the second CQI table.

The learned modulations may be based on an artificial intelligence/machine learning (AI/ML) model. The learned modulations may be characterized by a non-equal distance between constellations of each modulation order of the learned modulation orders. The preconfigured modulation orders may include, for example, one or more of Binary Phase-shift keying (BPSK), Quadrature Phase Shift Keying (QPSK), or 16-Quadrature amplitude modulation (QAM). The preconfigured modulation orders may be characterized by an equidistance between constellations of each modulation order of the preconfigured modulation orders.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2A is an illustration of an example learned constellation shape for modulation order 4.

FIG. 2B is an illustration of an example received symbols related to the learned constellation shape of FIG. 2A.

### DETAILED DESCRIPTION

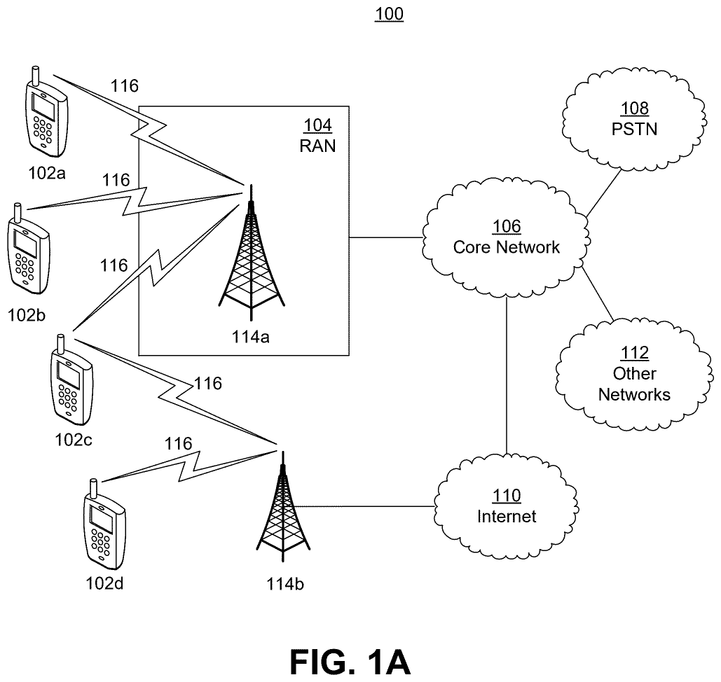

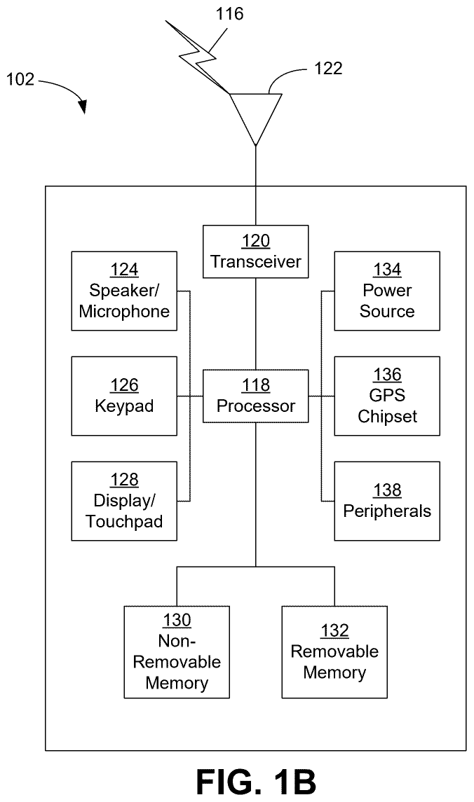

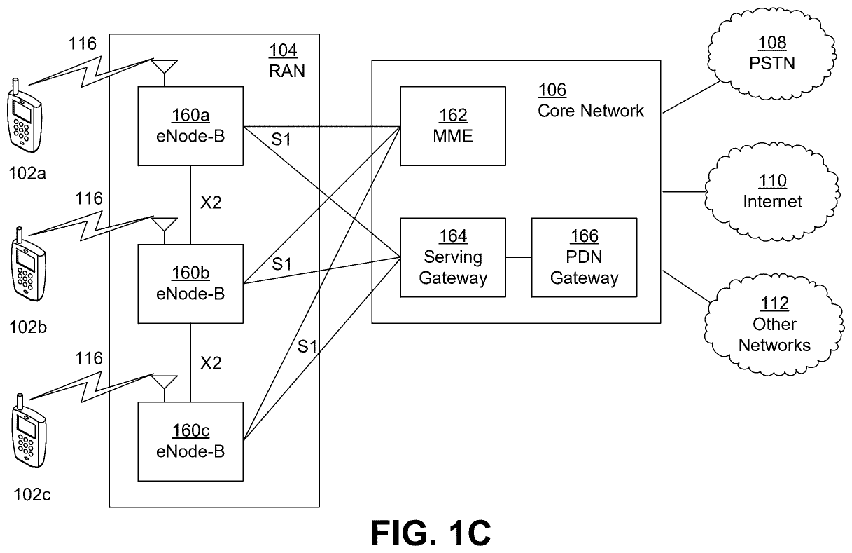

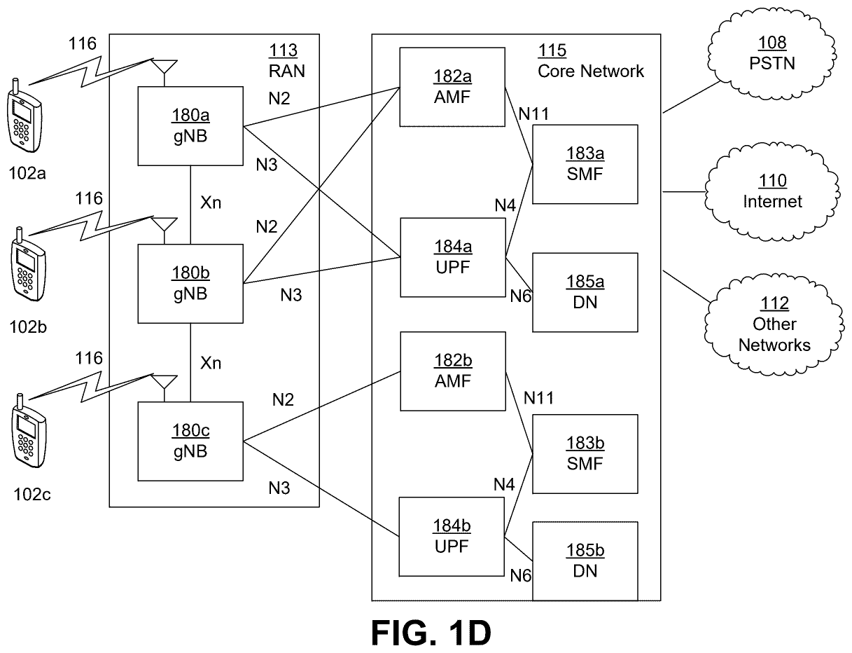

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a WTRU. Further, any description herein that is described with reference to a UE may be equally applicable to a WTRU (or vice versa). For example, a WTRU may be configured to perform any of the processes or procedures described herein as being performed by a UE (or vice versa).

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., a eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VOIP) services to one or more of the WTRUs 102a, 102b, 102c, 102d. The data may have varying quality of service (QOS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit 139 to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating WTRU IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-ab, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

A WTRU may receive configurations on dynamically (learned) modulation orders and/or constellations including, for example, Modulation and Coding Scheme (MCS) tables, de-mapper, and Channel Quality Indicator (CQI) computation type. The WTRU may perform measurements on Reference Signals (RSs) with different constellations. Based on the measurements, the WTRU may determine and/or feed back CQIs for dynamic and pre-configured constellations.

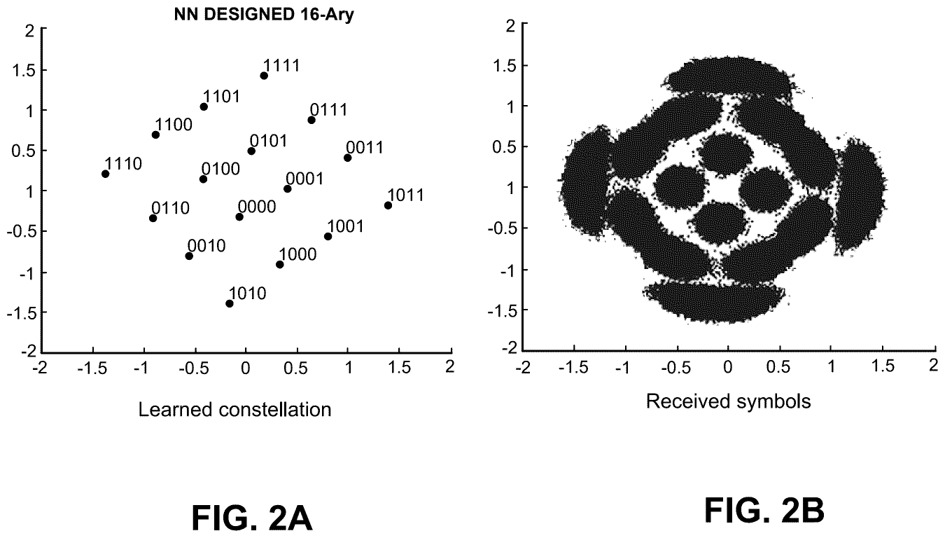

Learned constellation shapes may bring performance improvement in terms of Bit Error Rate (BER) and throughput. An example learned constellation shape for modulation order 4 (i.e., 4 bits per symbol) (e.g., neural network (NN) designed 16-ary) under non-linear phase noise is given in FIG. 2A, where the received symbols are also illustrated in FIG. 2B. When a WTRU has the capability to use learned constellations, the impacts of learned constellation on 3GPP procedures such as MCS tables, Channel State Information (CSI) reporting, Channel Quality Indicator (CQI) computation, CSI-Reference Signals (RS) signals and Hybrid Automatic Repeat Request (HARQ) processes may be provided herein. The examples described herein enable learned constellations and dynamic tables.

For example, a WTRU may be configured with one or more parameters associated with the operation of dynamically learned constellation. The configuration may include one or more of the following. For example, the configuration may include symbol to bits mapper/de-mapper for each learned modulation order and/or constellation (e.g. the de-mapper may be an autoencoder (AE) decoder, classifier, and/or decision regions, etc.). A learned modulation may be characterized by a non-equal distance between constellations of each modulation order. The configuration may include a CSI Computation and Reporting Configuration. For instance, the CSI Computation and Reporting Configuration may include one or more CQI table(s) of a first type (e.g., based on pre-configured modulation orders and/or constellation) and/or one or more CQI table(s) of a second type (e.g., based on one or more learned modulation order and/or constellation—e.g., possibly optimized for specific deployment or channel conditions). Each row of a CQI table may include at least one of: index, modulation order, coding rate, and/or learned constellation ID. The CSI Computation and Reporting Configuration may also include assistance for CQI computation (e.g., mapping of values from a table of a first type to a table of a second type, SINR-to-CQI table or SINR offset for CQI computation relative to a legacy CQI table). The configuration may include Modulation and Coding Scheme (MCS) Tables. For instance, the configuration may include one or more MCS table(s) of a first type (e.g., based on pre-configured modulation orders and/or constellations) and/or one or more MCS table(s) of a second type (e.g., based on one or more learned modulation order and/or constellation). The MCS tables may be configured such that each row of an MCS table may include at least one of: an index, a modulation order, and/or a coding rate. The configuration may include a DL Reference Signal (RS) configuration. For instance, the DL Rs configuration may include Type 1 RS (e.g. transmitted using pre-configured modulation order and/or constellation) resource allocation and/or Type 2 RS (e.g. transmitted using a learned modulation order and/or constellation) resource allocation.

The WTRU may receive Type 1 and Type 2 RS and compute measurements based on reference signal(s) type. For example, the computing measurements may include computing RS measurements for pre-configured and/or learned constellations (e.g., channel estimation performance metrics for Type-1 and Type-2 RS and/or computing the signal-to-noise-ratio (SNR) or mean square error (MSE) after channel equalization with Type-1 and Type-2 RS). For example, the computing measurements may include reporting the RS measurement for pre-configured and/or learned constellations (e.g. measurement per RS type, modulation order, selection on RS type and constellation/modulation order based on RS measurements, and/or selection on density of type-1 and type-2 RS).

The WTRU may select a CQI table (e.g., and/or CQI table Type) and may compute CQI based on any combination of the following rules. For example, the WTRU may select a CQI table type based on one or more preconfigured conditions. For instance, the WTRU may select a Type-2 CQI table if Type 2 MCS table is active and/or if Artificial Intelligence/Machine Learning (AI/ML) model associated with Type 2 MCS table is active. For instance, the WTRU may select a Type-2 CQI table if the channel estimation performance metric with Type-2 RS is higher than Type-1 RS. For instance, the WTRU may select a CQI table based on performance metrics (e.g., throughput, BLER, number of retransmissions, SNR thresholds, or other model performance metrics (e.g., out of distribution (OOD), etc.). For example, if Type 2 CQI table is selected, then the WTRU may compute CQI based on following. For instance, if Type 2 CQI table is selected, then the WTRU may compute CQI based on WTRU-determined CQI computation (e.g. the WTRU computes the CQI based on WTRU determined SINR-to-CQI). For instance, if Type 2 CQI table is selected, then the WTRU may compute CQI based on network (NW)-assisted CQI computation. The WTRU may compute NW-assisted CQI computation, for example, based on the SINR-offset for CQI received from NW within the MCS table configuration (e.g., as described in the examples herein, such as Table 3 and Table 4) and/or based on the SINR-to-CQI table received from NW).

The WTRU may report the CQI with one or more of the following. For instance, the WTRU may report the CQI with CQI Table type, or CQI Table index and a CQI index within the table, and/or Assistance information for fallback CQI (e.g., signal-to-interference plus noise ratio (SINR) offset with respect to type 1 CQI table or Type-1 CQI index).

The WTRU may receive downlink control information (DCI) allocating physical downlink shared channel (PDSCH) that may indicate, for example, receiving MCS Table type (implicit via preconfigured Radio Network Temporary Identifier (RNTI) or explicit via new field in DCI) and MSC index for PDSCH. The WTRU may receive DCI allocating PDSCH that may indicate, for example, receiving PDSCH symbols where the symbols are modulated based on the MCS table and the MCS Index. The WTRU may receive DCI allocating PDSCH that may indicate, for example, demodulating the symbols based on the configured de-mapper associated to the received MCS Table type.

A WTRU capable of using learned constellations may receive configuration associated with the dynamic determination and selection of the constellations. The configuration may include, for example, MCS configuration, CSI computation and reporting configuration, and/or downlink (DL) RS configuration. The WTRU may be configured semi-statically via radio resource control (RRC) configuration and it may be indicated dynamically via medium access control (MAC) control element (CE) or DCI (e.g., to switch from one type to another).

A WTRU capable of using learned constellations may receive new constellations (e.g., mapper) corresponding to different modulation orders and symbol demodulators (e.g., demapper). For example, the mapper and demapper may be obtained as part of a training (online and/or offline) based on channel statistics and/or based on real channel measurements. The mapper may represent the bits-to-symbol modulation and the demapper may represent the received symbols to bits (or soft bits) demodulator. The mapper and/or demapper may be learned (e.g., trained with datasets) through neural networks (e.g., autoencoders), where at the end of training, the encoder of the autoencoder may constitute the mapper and decoder of the autoencoder may constitute the demapper. The input to the encoder may be bits (e.g., from the output of the channel encoder), for example, where the number of inputs determine the modulation order. The output of the encoder may be one or more complex numbers that represent the modulated symbols at the transmitter. The input to the decoder may be the received complex symbols at the receiver. The output of the decoder may be the recovered bits (or soft bits) that may be used as input to the channel decoder.

The MCS configuration may include one or more MCS tables, with at least one MCS table of Type 1, and/or one or more MCS tables of Type 2. For example, MCS Type 1 tables may be predefined (e.g., preconfigured and/or specified) and may use traditional constellations, such as QPSK, 16-QAM, 64-QAM and higher-order QAM modulations. For example, MCS Type 2 tables may use learned constellations, or a combination of traditional and learned constellations. For instance, an MCS Type 2 table may use a traditional QPSK constellation for a modulation order of 2 and may use learned constellation for modulation order larger than 2. For instance, an MCS Type 2 table may use (e.g., only use) learned constellations for every MCS index and for every modulation order in the table. For instance, an MCS Type 2 table may use a different constellation (e.g., traditional or learned) for each row of the table (e.g., for each MCS index).

The configuration of an MCS Type 2 table may include any of the following. For example, a MCS Table ID may be used to select an MCS Table based on operating conditions or deployments. For instance, an MCS Type 2 table with learned constellations to mitigate phase noise may be used when the WTRU operates in the higher frequency bands. For instance, an MCS Type 2 table with learned constellations to mitigate non-linear power amplifiers, may be used when the WTRU operates in power limited scenarios.

The configuration of an MCS Type 2 table may include, for example, the WTRU being configured with a de-mapper. The de-mapper may be a decoder (e.g., of an autoencoder), classifier and/or decision regions. The de-mapper may be used to reconstruct the transmitted log likelihood ratios (LLRs) and/or received bits and/or soft bits. The de-mapper input may be one or more complex received symbols. If the modulation order is denoted with M, then the output of the de-mapper may be, e.g., M bits, M LLRs, or any M values to reconstruct received bits, LLRs, and/or soft-bits.

For each row of the MCS Type 2 table, the configuration may include the following. For example, the configuration may include a MCS index. For example, the configuration may include a Modulation order. For example, the configuration may include a coding rate for the data channel. For example, the configuration may include a constellation indicator. For example, the configuration may include a symbol to bits de-mapper indicator. When the symbol to bits de-mapper indicator is present, this field may indicate an AE decoder, ML classifier model, and/or define the decision regions for the de-mapping operation.

The constellation indicator element of a row of MCS Type 2 table may indicate the use of a traditional or a learned constellation. For example, the constellation indicator may be zero when a traditional constellation is used, and non-zero when a learned constellation is used for the corresponding MCS index. The constellation indicator may further indicate the bit-to-symbol mapper. For example, the constellation indicator may be zero when a traditional constellation is used for the corresponding MCS index. This may implicitly indicate the use of predefined (e.g., specified) bits-to-symbol mapper associated to the modulation order for that MCS index. A non-zero value of the constellation indicator may point to the bits-to-symbol mapper table for the learned constellation to be used for the MCS index and the associated modulation order.

Examples of the bits to symbol mapping tables for learned constellation for modulation order 2 and modulation order 4 are shown in Table 1 and Table 2 below.

TABLE 1
Example of bits to symbol mapping table
for learned constellation of order 2

| Bits | Symbol |
|---|---|
| 00 | 0.45 + 0.97i |
| 01 | −0.32 + 0.53i |
| . . . | . . . |

TABLE 2
Example of bits to symbol mapping table
for learned constellation of order 4

| Bits | Symbol |
|---|---|
| 0000 | −0.1 − 0.4i |
| 0001 | 0.4 − −0.1i |
| . . . | . . . |
| 1111 | 0.2 + 1.4i |

In some examples, a configuration of Type 2 MCS table may implicitly use a Type 1 MCS table structure, where the modulation order field is replaced by an index to a learned constellation.

The configuration of CSI computation may include one or more CQI tables, with at least one CQI table of Type 1, one or more CQI tables of Type 2, and/or a type of CQI computation. For example, CQI Type 1 tables may be predefined (e.g., specified) and may be associated with the configured MCS Type 1 tables, where CQI Type 1 tables may use traditional constellations, such as QPSK, 16-QAM, 64-QAM and higher-order QAM modulations. For example, CQI Type 2 tables may correspond to learned constellations and may be associated with the configured MCS Type 2 tables. For instance, the configuration of a CQI Type 2 table may include a CQI Table ID associated with a configured MCS Table ID.

In a CQI Type 2 table, for example, each row may correspond to a CQI index and may include modulation order, coding rate for the data channel, and a constellation indicator. The constellation indicator may indicate the use of a traditional or a learned constellation. For instance, the constellation indicator may be zero when a traditional constellation is used. For instance, the constellation indicator may be non-zero when a learned constellation is used for the corresponding CQI index.

The CQI Type 2 table may further include information to enable CQI calculate relative to Type 1 CQI tables. For example, the information may consist of SNR offset with respect to a Type 1 CQI table, as shown in Table 3.

TABLE 3
CQI to MCS mapping table with SNR offset - example 1

| | | Code | | SNR Offset with |
|---|---|---|---|---|
| CQI | | rate × | | respect to legacy |
| Index | Modulation | 1024 | Efficiency | Table 2 (dB) |
| 0 | — | — | — | |
| 1 | 2-bits | 80 | 0.1563 | −0.5 |
| 2 | 2-bits | 180 | 0.3516 | −0.7 |
| . . . | 3-bits | . . . | . . . | . . . |
| 15 | 7-bits | | | |

In some examples, the information may consist of row indices from Type 1 CQI tables, as shown in Table 4.

TABLE 4
CQI to MCS mapping table with relative
index to legacy tables - example 2

| | | Code | | Relative index |
|---|---|---|---|---|
| CQI | | rate × | | from legacy |
| Index | Modulation | 1024 | Efficiency | tables |
| 0 | | | | |
| 1 | 2-bits | 80 | 0.1563 | Table 2- Index 1 |
| 2 | 2-bits | 180 | 0.3516 | Table 3- Index 1 |
| 3 | 3-bits | ... | ... | Table 2- Index 2 |
| . . . | | | | |
| 15 | 7-bits | | | |

The configuration of CSI computation may further include, for example, a type of CQI computation, where the type of computation may be WTRU determined, or NW assisted. For example, for WTRU determined CQI computation, the WTRU uses the determined SINR-to-CQI mapping to compute the CQI index, based on the configured CQI table. For example, for the NW-assisted CQI computation, the WTRU may receive assistance information such as SINR-to-CQI table or SNR/SINR offset for CQI computation relative to an indicated Type1 CQI table.

The downlink (DL) RS configuration may include a Type 1 RS configuration, and a Type 2 RS configuration. For example, the Type 1 RS configuration may correspond to predefined (e.g., standard defined) constellations (e.g., and correspond to Type 1 MCS and Type 1 CQI tables). For example, the Type 2 RS configuration may correspond to learned constellations and may be associated with the configured Type 2 MCS and Type 2 CQI tables.

The downlink RS configuration may include the resource configuration for Type 1 RS and/or Type 2 RS. For example, the resource configuration may include the RS period, the RS resource mapping, and/or the resource type (periodic, semi-persistent, or aperiodic). For example, the resource configuration may include densities of Type-1 and/or Type-2 RS (e.g., percentage of resources allocated to types of DL RS). For example, the configuration on DL RS may include indication of the sequences of Type-1 and Type-2 DL RS symbols, where the order of RL symbols from a constellation may be determined.

A WTRU that is configured to determine the type of reference signals (RSs) may receive the configured DL RS (e.g., Channel State Information-Reference Signal (CSI-RS), Demodulation Reference Signal (DM-RS), etc.). The DL RS may be of one or more types. For example, the DL RS may be Type-1 RS where the symbols may be based on legacy symbols from legacy constellations (e.g., QPSK). For example, the DL RS may be Type-2 RS where the symbols may be based on learned constellations in Type-2 MCS table. When the DL RS symbols are based on a constellation and modulation order, the DL RS symbols may be determined based on a predetermined sequence. For instance, each element in the sequence may be selected from a set of constellation symbols. The WTRU may be configured with different densities of DL RS types. For example, 50% of DL RS resources may be dedicated to Type-1 RS and/or 50% of the DL RS resources may be dedicated to Type-2 RS. For example, the density of DL RS resource types may be configured dynamically, semi-statically, periodically and/or aperiodically. For example, Type 2 DL RS may further be configured to be selected (e.g., selected by the WTRU) from different constellations with different modulation orders.

The WTRU may compute the channel estimation performance metrics corresponding to different types of DL RS (e.g. Type-1 DL RS and Type-2 DL RS). The channel estimation performance metric may be computed based on the following example options. For example, the channel estimation performance metric may be computed based on SNR after equalization. For instance, the WTRU may receive DL RS with different types, (e.g., Type-1 DL RS and Type-2 DL RS). The WTRU may compute two channel estimates: H1 using the Type-1 DL RS, and/or H2 using the Type-2 DL RS. The WTRU may compute a SNR1 after equalization with H1 and/or a SNR2 after channel equalization with H2. For example, the channel estimation performance metric may be computed based on Mean Squared Error (MSE) after equalization. For instance, the WTRU may receive DL RS with different types (e.g. Type-1 DL RS and Type-2 DL RS). The WTRU may compute two channel estimates: H1 using the Type-1 DL RS, and H2 using the Type-2 DL RS. The WTRU may compute a MSE1 between equalized received symbols with H1 and transmitted symbols and a MSE2 between equalized received symbols with H2 and transmitted symbols. For example, the WTRU may receive DL RS with different types (e.g. Type-1 DL RS and Type-2 DL RS). The WTRU may compute a channel estimate H3 by combined DL RS where, for example, the Type-1 DL RS constitutes R % and/or Type-2 DL RS constitutes (100-R) % of the DL RS that are used for estimating H3. The WTRU may compute channel estimation performance metrics for one or more values of R that represent the density of Type-1 to Type-2 DL RS. For example, the WTRU may compute the channel estimation performance per sub-band for Type-1 and Type-2 RS. For example, the WTRU may compute channel estimation performance per modulation order for Type-1 and Type-2 RS.

The WTRU may select the type of DL RS based on the channel estimation performance metric. For example, the WTRU may select the type with highest SNR after equalization (e.g., or lowest MSE). For example, the WTRU may select Type-2 if SNR2 is greater SNR1, or MSE2 is lower than MSE1. For example, the WTRU may be configured with Type-2 DL RS with more than one modulation order (e.g., different learned constellations). For example, the WTRU may select the preferred modulation order based on the channel estimation performance metric for Type-2 DL RS. For instance, the WTRU may further select the best ratio R for the density of Type-1 DL RS and Type-2 DL RS by comparing the channel estimation performance metric for one or more values of R. For instance, the WTRU may select the type of DL RS based on the channel estimation performance metric per subband. The WTRU may select the type of DL RS with highest SNR after equalization (e.g., or lowest MSE) per subband. For instance, if more than a certain percentage of the number of subbands require a specific type (e.g., Type-2), the WTRU may select the specific type (e.g., Type-2) for wideband and subband DL RS (e.g., all wideband and subband DL RS).

The WTRU may report RS measurements report. For example, the WTRU may report a comparison of DL RS with different RS type and modulation order. For instance, the WTRU may report the results of the RS measurement report per type of DL RS. The WTRU may report the type of DL RS (e.g., Type-1 or Type-2) with best performance metric. For instance, the WTRU may report the results of the RS measurement report per subband. The WTRU may report the best RS type per subband. For instance, the WTRU may report the results of the RS measurement report per modulation order. The WTRU may report the best RS type per modulation order. For instance, the WTRU may report the results of the RS measurement report with ratio of Type-1 and Type-2 RS. The WTRU may report the ratio of Type-1 and Type-2 RS with best performance metric. For instance, the WTRU may report the results of the RS measurement report using different types of RS (e.g., including the SNR or MSE per RS type).

A WTRU capable of dynamic MCS tables may determine a CQI table type based on one of more of the following. For example, a WTRU may determine the CQI table based on MCS table configuration. For instance, if the WTRU is configured to use Type-1 MCS table, then the WTRU may choose the corresponding pre-configured Type-1 CQI Table. For instance, if the WTRU is configured to use a Type-2 MCS table, then the WTRU may choose the dynamically configured Type-2 CQI table. For example, a WTRU may determine the CQI table based on the RS measurements with different RS types. For instance, the WTRU may determine to use Type-2 CQI table if the RS measurements of Type-2 RS is better than Type-2 (e.g., SNR2 greater than SNR1 and/or MSE2 lower than MSE1). For example, a WTRU may determine the CQI table based on performance metrics (e.g., throughput, BLER, number of retransmissions). For instance, if a performance metric with Type-2 MCS table is greater than Type-1 MCS table, then the WTRU may select Type-2 CQI table. For example, a WTRU may determine the CQI table based on configured conditions (e.g., SNR thresholds, channel conditions, WTRU speed, peak-to-average-power ratio (PAPR)). The WTRU may determine the CQI table type based on configured performance thresholds. For instance, when the SNR is above a threshold, Type-1 CQI table is selected. For example, the WTRU may determine the CQI table type based on model monitoring metrics. For instance, the WTRU may determine the CQI table type based on model monitoring metrics (e.g., out of distribution, cosine similarity, etc.). For example, the WTRU may determine the CQI table type per subband. For instance, the WTRU may be configured to determine the CQI table per subband and, for instance, use RS measurements per subband to determine the CQI table per subband. For instance, if more than a certain percentage of sub-bands require Type-2 CQI then all sub-band and wideband CQI may be Type-2 CQI.

If the WTRU has determined Type-2 CQI for the CSI reporting of any of the configured resources, the WTRU may compute the CQI value based on Type-2 CQI. For example, the WTRU may compute Type-2 CQI based on the following options. For example, the WTRU may compute Type-2 CQI based on a WTRU determined CQI computation method. For instance, the WTRU may compute its own CQI computation method based on the received configuration on Type-2 MCS table, constellations for each modulation order, and/or de-mapper. For instance, the WTRU may compute an SINR-to-CQI mapping based on the received configurations. For instance, the WTRU may compute an SINR-to-CQI mapping table by its own internal processing and/or the WTRU may transfer the information to a WTRU-side (e.g. server) to compute the SINR-to-CQI mapping. The SINR-to-CQI mapping may consist of determining SINR regions where a specific CQI value is valid (e.g. requirements on BER may be satisfied). For example, the WTRU may further compute an assistance information for the NW, in case the NW decides to fallback to Type-1 (e.g. legacy) CQI table. For instance, the assistance information may consist of an SNR offset value compared to an index in the Type-1 CQI table. The SNR offset associated with an index in Type-2 CQI table may indicate the required SNR offset to attain the similar requirements (e.g. BER) with respect to an index of Type-1 CQI table. For instance, the assistance information may consist of Type-1 CQI value. For example, the WTRU may compute Type-2 CQI based on a NW assisted CQI computation method. For instance, the WTRU may receive the method to compute CQI (e.g. SINR-to-CQI table associated with a Type-2 CQI table). The WTRU may receive an SINR-to-CQI mapping table where the WTRU may compute the CQI based on the SINR (or SNR) computed using the received reference signals (e.g., CSI-RS). For instance, the WTRU may receive offset SNR value accompanied within the new Type-2 CQI table configuration (e.g. Table 3). For instance, the offset SNR values in Type-2 CQI table may be relative to a Type-1 CQI table indicating the relative SNR change to satisfy the same performance requirements (e.g. BER). The WTRU may use the assistance information to update its own computation method for CQI. For instance, the WTRU may receive related indices from Type-1 CQI tables that may be equivalent (e.g., satisfy same requirements, such as BER) to Type-2 CQI indices within the Type-2 CQI table configuration (e.g., Table 4). The WTRU may use the related indices to update its own SINR-to-CQI mapping designed for Type-1 CQI and generate CQI index for Type-2 CQI table.

The WTRU may report CQI information including one or more of the following. For example, the WTRU may report a CQI Table Type. For instance, the WTRU may report the determined CQI table type for each of the subbands separately. For instance, the WTRU may report one CQI table type per all resources. For example, the WTRU may report a CQI Index with the table. For instance, the WTRU may report the determined CQI index from the determined CQI table type. For example, the WTRU may report Assistance for fallback Type-1 CQI, in case Type-2 CQI table is selected. For instance, the WTRU may report assistance information to NW in case the NW needs to issue a Type-1 CQI fallback decision. For instance, the WTRU may feedback SNR offset value relative to a Type-1 CQI index. For example, the WTRU may report Type-1 CQI periodically and Type-2 CQI aperiodically. For example, the WTRU may report Type-2 CQI periodically and Type-2 CQI aperiodically. For example, the WTRU may use legacy reporting resources for Type-1 CQI. For instance, Type-2 CQI reporting resources may be configured with new physical uplink control channel (PUCCH) resources. For example, the WTRU may use one or more of the following CSI reporting format options. For instance, the WTRU may use Format 1. Format 1 may consist of legacy CQI/precoding matrix indicator (PMI)/rank indicator (RI), where the WTRU may report legacy CSI/CQI. For instance, the WTRU may use Format 2. Format 2 may consist of CQI type 1 and CQI type 2, where the WTRU may report two CQI values, Type-1 CQI and Type-2 CQI. For instance, the WTRU may use Format 3. Format 3 may consist of CQI type 2 and offset to CQI type1, where the WTRU may report Type-2 CQI and offset to Type-1 CQI. For instance, the WTRU may use Format 4.Format 4 may consist of conditional (e.g., type 1 or type 2), where the WTRU may report Type-1 or Type-2 based on the conditions and configurations.

The WTRU may be preconfigured with one or more MCS table of a first MCS table Type (e.g., MCS table Type 1) and one or more MCS table of a second MCS table Type (e.g., MCS table Type 2). For example, the MCS table Type 1 may be preconfigured or predefined. For example, the MCS table type 1 may be based on QPSK/QAM modulation. For example, the MCS table Type 2 may be dynamically configured for a WTRU. For example, the MCS table Type 2 may be based on constellations optimized for a specific deployment, specific device/type, specific service, specific quality of service requirement etc.

The WTRU may be configured to determine the MCS type associated with PDSCH reception. The WTRU may be configured to determine the MCS table type in a downlink control information. The WTRU may receive an indication in the Downlink Control Information (DCI) indicating the MCS table type associated with PDSCH. The MCS table type indication in the DCI may be explicit. For example, the MCS table type indication field and/or flag in DCI may indicate if the PDSCH is modulated based on MCS table Type 1 or MCS Table type 2. For example, the MCS table type indication field in DCI may indicate that the PDSCH is modulated based on MCS table Type 2. For example, the absence of MCS table type indication field in the DCI may be interpreted as MCS table Type 1 by the WTRU. The WTRU may be configured with a first DCI format and a second DCI format. The first DCI format may be legacy DCI format. The second DCI format may carry the MCS table type indication. Upon receiving the indication of MCS table type 2, the WTRU may interpret the MCS indication in the DCI to be associated with second MCS table. When more than one MCS table is configured with second MCS table type, the DCI may additionally indicate the MCS table to be selected for MCS determination.

The MCS table type indication in DCI may be implicit. For example, the WTRU may be configured with a first RNTI and a second RNTI. The first RNTI, for instance, may be associated with DCI's scheduling PDSCH with first MCS table type. The second RNTI, for instance, may be associated with DCI's scheduling PDSCH with second MCS table type. Upon receiving a physical downlink control channel (PDCCH) with cyclic redundancy check (CRC) scrambled by second RNTI, the WTRU may interpret the MCS indication in the DCI to be associated with second MCS table type. For example, when more than one MCS table is configured with second MCS table type, the DCI may additionally indicate the MCS table to be selected for MCS determination.

The WTRU may determine the MCS table type based on property of PDCCH. For example, the WTRU may be configured with first PDCCH search space and a second PDCCH search space. If a WTRU receives a DCI in a first PDCCH search space the WTRU may use the MCS table type 1 for MCS determination. If the WTRU receives a DCI in a second PDCCH search space, the WTRU may use the MCS table type 2 for MCS determination. In other examples, the WTRU may use other properties of PDCCH, such as search space identity, control resource set (CORESET) and/or PDCCH candidates to indicate the MCS table type.

The WTRU may be configured to activate and/or deactivate the reception of PDSCH with MCS table type 2 based on medium access control (MAC) control element (CE). For example, upon reception of MAC CE activating MCS table type 2, the WTRU may start to monitor the second RNTI. For example, upon reception of MAC CE activating MCS table type 2, the WTRU may start to monitor the second DCI format and/or PDSCH search space and/or CORESET associated with MCS table type 2. For instance, the WTRU may be configured to start monitoring DCI associated with MCS table type 2 PDSCH reception based on RRC configuration message.

For example, upon receiving PDSCH with MCS table type 2, the WTRU may use the MCS indicated in the DCI and the configured MCS table associated with the table type (e.g., table Type 2) to determine one or more of: modulation order, modulation scheme (e.g., constellation) and/or target code rate of the physical downlink shared channel. For the PDSCH with MCS from the MCS table Type 2, the WTRU may use one or more of the following to de-map the received symbols to (soft) bits: a configured AE decoder, classifier, and/or decision regions. For example, the WTRU may use an AI/ML model to de-map the received symbols to the (e.g., soft) bits. The WTRU may be configured with different AI/ML models for different modulation orders. For instance, the WTRU may select the AI/ML model based on the determined modulation order and/or modulation scheme.

In the case of retransmissions, the WTRU may determine statically or dynamically the MCS table to use. For example, the WTRU may receive a DCI indication to fallback to legacy downlink/uplink (DL/UL) table and MCS index with same modulation order and coding rate. For example, WTRU may use the configured order and/or pattern of MCS tables for consecutive retransmissions. For instance, the WTRU may use legacy Type 1 MCS table for all the subsequent retransmissions. For instance, the WTRU may use a specific configured pattern (e.g. a combination of legacy Type 1 and a learned Type 2 MCS table). For instance, the WTRU may be configured to dynamically determine a combination of different Type 2 MCS tables (e.g. when the WTRU is configured with more than one Type MCS table). For example, the WTRU may keep track of the historical performance of different MCS tables combinations for retransmissions. For instance, the WTRU may use additional side-information (e.g. a set of applicable conditions) to optimize the dynamic MCS table selection procedure while maintaining a desired performance. For instance, the WTRU may be configured with one or more thresholds on the acknowledgement/negative acknowledgement (ACK/NACK) frequency, where the WTRU may select and/or maintain the combinations of MCS tables for retransmissions that may meet the configured threshold(s). For example, the WTRU may feedback its MCS table preference (e.g., Type 1 or Type 2) computed based on channel estimation performance metrics. For instance, a CRC fail (e.g., NACK) may trigger channel estimation performance report for the same modulation order in all MCS tables, where the report may be constructed through historically stored RS with different constellations. For instance, the WTRU may optionally use other metrics to determine the MCS table preference (e.g. metrics based on collected measurements on inputs, and/or metrics collected from applicable conditions).

The WTRU capable of using learned constellations may receive configuration associated with the dynamic determination and selection of the constellations. The configuration may include, for example, MCS configuration, bits to symbol mapper, and uplink (UL) sounding reference signal (SRS) configuration. The WTRU may be configured semi-statically via RRC configuration, and the configuration(s) may be indicated dynamically via MAC CE or DCI (e.g., to switch from one type to another).

The WTRU may implement methods on dynamic constellations and MCS tables in the uplink. For example, the WTRU may be configured with one or more parameters associated with the operation of dynamic MCS tables for UL, where the configuration may include one or more of the following. For instance, the configuration for the WTRU may include Type 1 and Type 2 MCS tables. For instance, at least one MCS table of type 1 may be, for example, predefined and the WTRU may receive configuration of more or more MCS tables of the type 2. For example, the Type 1 MCS table may be legacy MCS tables, such as BPSK, QPSK, 16QAM, 32QAM, and/or 64QAM. The Type 2 MCS table may be learned constellation based (e.g., dynamically determined). For instance, the configuration of Type 2 MCS table(s) may include an indication on the modulation order and coding rate of the DL data, where each row may include at least an index, modulation order and coding rate. For example, the indication may include an implicit table (e.g. reuse type 1 table but redefine the constellation each modulation order-e.g., by redefining QPSK to a new constellation (e.g., learned constellation)). For example, the indication may include an explicit table (e.g., new table or subset of type 1 table etc.). For example, the configuration of Type 2 MCS table(s) may include bits to symbol mapper for each modulation order. For instance, the mapper may be an AE encoder, or expressed as a look-up table and constellations for each modulation order. For example, the configuration for the WTRU may include SRS type configuration. For instance, the SRS type configuration may be Type 1 SRS (e.g., legacy) and/or Type 2 SRS. For instance, the type 2 RS may be transmitted via the modulation order to select from the type 2 MCS table (e.g. resource allocations for Type 1 and Type 2 SRS).

The WTRU may receive DCI allocating PUSCH that may indicate receiving MCS Table type (e.g. implicit via preconfigured RNTI or explicit via new field in DCI) and/or the MSC index for a PUSCH transmission. For example, the WTRU may receive DCI allocating a PUSCH transmission that may indicate mapping bits to symbol based on the received MCS Table type, MCS Index, and/or configured mapper. For example, the WTRU may receive DCI allocating a PUSCH transmission that may indicate PUSCH symbols.

The WTRU may determine SRS type based on preconfigured mapping (e.g. function of resource type and/or resource) and/or Semi-static/Dynamic indication. For example, preconfigured mapping or semi-static/dynamic indication may be periodic SRS-Type1 and/or Aperiodic SRS-Type: 2. For example, preconfigured mapping or semi-static/dynamic indication may be PUCCH resource 1 (e.g., less frequent) and/or PUCCH resource 2 (e.g., more frequent). The SRS type to map to these resources may be dynamic (e.g. MAC CE activates and/or deactivates the mapping of SRS type).

The MCS configuration may include one or more MCS tables, with at least one MCS table of Type 1 and one or more MCS tables of Type 2. For example, MCS Type 1 tables may be predefined (e.g., specified) and may use traditional constellations, such as QPSK, 16-QAM, 64-QAM and/or higher-order QAM modulations. For example, MCS Type 2 tables may use learned constellations, or a combination of traditional and/or learned constellations. For instance, an MCS Type 2 table may use a traditional QPSK constellation for a modulation order of 2 and may use learned constellation for modulation order larger than 2. For instance, an MCS Type 2 table may use (e.g. only use) learned constellations for every MCS index and for every modulation order in the table. For instance, an MCS Type 2 table may use a different constellation (traditional and/or learned) for each row of the table (e.g. for each MCS index).

The configuration of an MCS Type 2 table may include any of the following. For example, the configuration of an MCS Type 2 table may include MCS Table ID. The MCS Table ID may be used to select an MCS Table based on operating conditions or deployments. For instance, an MCS Type 2 table with learned constellations to mitigate phase noise may be used when the WTRU operates in the higher frequency bands. For instance, an MCS Type 2 table with learned constellations to mitigate non-linear power amplifiers, may be used when the WTRU operates in power limited scenarios. For example, the configuration of an MCS Type 2 table may include bits to symbols mapper. For instance, the WTRU may receive configuration on the bits to symbol mapper (e.g., a mapping table belongs to a learned constellation). Examples of 2 bit and 4 bits mappers are provided in Table 1 and Table 2. For instance, the WTRU may be configured with the encoder model of an autoencoder. For example, for each row of the MCS Type 2 table, the configuration may include a MCS index. For each row of the MCS Type 2 table, the configuration may include Modulation order. For each row of the MCS Type 2 table, the configuration may include coding rate for the data channel. For each row of the MCS Type 2 table, the configuration may include constellation indicator.

The constellation indicator element of a row of MCS Type 2 table may indicate the use of a traditional and/or a learned constellation. For example, the constellation indicator may be zero when a traditional constellation is used, and non-zero when a learned constellation is used for the corresponding MCS index. For instance, the constellation indicator may further indicate the bits-to-symbol mapper. For example, the constellation indicator may be zero when a traditional constellation is used for the corresponding MCS index. For instance, this may implicitly indicate the use of predefined (e.g., specified) bits-to-symbol mapper associated to the modulation order for that MCS index. For instance, a non-zero value of the constellation indicator may point to the bits-to-symbol mapper table for the learned constellation to be used for the MCS index and the associated modulation order.

For example, a configuration of Type 2 MCS table may implicitly use a Type 1 MCS table structure, where the modulation order field is replaced by an index to a learned constellation. For example, a configuration of Type 2 MCS table may include an explicit indication of the AI/ML model (e.g., AE or classifier) used to apply bits-to-symbol mapping (e.g., when the new constellation mapper is adaptive). For example, the WTRU may be configured with additional information for Type 2 MCS. For instance, a set of assistance information or side-information used as input to the AI/ML based constellation mapper.

The uplink (UL) SRS configuration may include a Type 1 SRS configuration, and a Type 2 SRS configuration. For example, Type 1 SRS configuration may correspond to predefined (e.g., legacy) constellations (e.g., and may correspond to Type 1 MCS and/or Type 1 CQI tables). For example, Type 2 SRS configuration may correspond to learned constellations and may be associated with the configured Type 2 MCS and Type 2 CQI tables. For instance, Type 2 SRS may be transmitted using a modulation order to select from the Type 2 MCS table. The uplink SRS configuration may include the resource configuration for Type 1 SRS and Type 2 SRS. For example, Type 2 SRS may use one or more Type 2 MCS tables. The resource configuration for SRS may include the SRS periodicity, SRS resource mapping, and/or resource type (e.g., periodic, semi-persistent, or aperiodic).

The WTRU may be preconfigured with one or more MCS table of a first MCS table type (e.g., MCS table Type 1) and one or more MCS table of a second MCS table type (e.g., MCS table Type 2). For example, the MCS table Type 1 may be preconfigured or predefined. For example, the MCS table Type 1 may be based on QPSK/QAM modulation. For example, the MCS table Type 2 may be dynamically configured for a WTRU. For example, the MCS table Type 2 may be based on constellations optimized for a specific deployment, specific device/type, specific service, and/or specific quality of service requirement.

The WTRU may be configured to determine the MCS type associated with a PUSCH transmission. For example, the WTRU may be configured to determine the MCS table type in a downlink control information. For example, the WTRU may receive an indication in the DCI indicating the MCS table type associated with PUSCH. For example, the MCS table type indication in the DCI may be explicit. For example, the MCS table type indication field and/or flag in DCI may indicate if the PUSCH is modulated based on MCS table Type 1 or MCS table Type 2. For example, the MCS table type indication field in DCI may indicate that the PUSCH is modulated based on MCS table Type 2. For instance, the absence of MCS table type indication field in the DCI may be interpreted as MCS table Type 1 by the WTRU. For example, the WTRU may be configured with a first DCI format and a second DCI format. The first DCI format may be legacy DCI format. The second DCI format may carry the MCS table type indication. Upon receiving the indication of MCS table Type 2, the WTRU may interpret the MCS indication in the DCI to be associated with second MCS table. When more than one MCS table is configured with second MCS table type, the DCI may additionally indicate the MCS table to be selected for MCS determination.

The MCS table type indication in DCI may be implicit. For instance, the WTRU may be configured with a first RNTI and a second RNTI wherein the first RNTI may be associated with DCI's scheduling PUSCH with first MCS table type and the second RNTI may be associated with DCI's scheduling PUSCH with second MCS table type. Upon receiving a PDCCH with CRC scrambled by second RNTI, the WTRU may interpret the MCS indication in the DCI to be associated with second MCS table type. When more than one MCS table is configured with second MCS table type, the DCI may additionally indicate the MCS table to be selected for MCS determination.

The WTRU may determine the MCS table type based on property of physical downlink control channel (PDCCH). For example, the WRTU may be configured with first PDCCH search space and a second PDCCH search space. If a WTRU receives a DCI in a first PDCCH search space the WTRU may use the MCS table Type 1 for MCS determination. If the WTRU receives a DCI in a second PDCCH search space, the WTRU may use the MCS table type 2 for MCS determination. Similar examples may be envisioned by using other properties of PDCCH such as search space identity, CORESET and PDCCH candidates to indicate the MCS table type.

The WTRU may be configured to activate and/or deactivate the transmission of PUSCH with MCS table type 2 based on MAC CE. For instance, upon reception of MAC CE activating MCS table type 2, the WTRU may start to monitor the second RNTI. For instance, upon reception of MAC CE activating MCS table type 2, the WTRU may start to monitor the second DCI format/PDCCH search space/CORESET associated with MCS table type 2. For instance, the WTRU may be configured to start monitoring DCI associated with MCS table Type 2 PUSCH transmission based on RRC configuration message.

Upon receiving DCI with uplink grant indicating the MCS table Type 2, the WTRU may use the MCS indicated in the DCI and the configured MCS table associated with the table type (e.g., table type: 2) to determine one or more of: modulation order, modulation scheme (e.g., constellation) and/or target code rate of the physical uplink shared channel. For the PUSCH with MCS from the MCS table type 2, the WTRU may use one or more of the following to map the bits to transmitted symbols bits: a configured AE decoder, classifier, and/or mapper etc. For instance, the WTRU may use an AI/ML model to map the bits to modulated symbols. For instance, the WTRU may be configured with different AI/ML models for different modulation orders. The WTRU may select the AI/ML model based on the determined modulation order and/or modulation scheme.

The WTRU may transmit SRS as a function of MCS table type configured for the UL transmission. For example, the WTRU may determine the modulation to be applied SRS sequence based on preconfigured conditions and/or rules. For example, the modulation scheme to be applied for the SRS transmission may be a function of one or more of the following: SRS resource configuration, type of SRS resource (e.g., periodic vs aperiodic), and/or type of modulation applied for UL PUSCH transmission, etc.

The WTRU may be configured with a first SRS resource and a second SRS resource. The WTRU may be configured with a first SRS sequence and a second SRS sequence. For instance, the first SRS sequence may be based on legacy and second SRS sequence may be modulated with modulation scheme from MCS table type: 2. For instance, the WTRU may be configured to transmit first SRS sequence on the first SRS resource and second SRS sequence on the second SRS resource. For instance, the WTRU may be configured to determine the type of SRS sequence to use for a specific SRS resource. For example, the first SRS resource may be a periodic resource and second SRS resource may be aperiodic resource. The WTRU may apply a first SRS sequence for periodic resource and second SRS sequence for the aperiodic resource. For example, the WTRU may be explicitly signaled in the aperiodic request for the type of SRS sequence to be applied for the second SRS resource.

The WTRU may receive activation and/or deactivation of second SRS resource in a MAC CE or in a DCI. Upon activation of the second SRS resource, the WTRU may transmit the second SRS sequence on the second SRS resource. For example, the WTRU may be configured to determine that the second SRS resource is active as a function of the availability of configuration of bits to symbol mapping configuration. For example, when the WTRU is configured with MCS table type: 2 and/or the bits to symbol mapping configuration, the WTRU may assume that the second SRS resource is deactivated. For instance, the WTRU may be configured to determine that the second SRS resource is active as a function of the modulation scheme applied for the UL PUSCH transmission. For example, when MCS table type: 1 is configured for UL PUSCH transmission, the WTRU may assume that the second SRS resource is deactivated. For example, when MCS table type: 2 is configured for UL PUSCH transmission, the WTRU may assume that the second SRS resource is activated. When the second SRS resource is activated, the WTRU may transmit the second SRS sequence on the second SRS resource using the modulation scheme configured for MCS table type: 2. For example, the first SRS resource may be configured to be more frequent and/or dense, and second SRS resource may be configured to be less frequent. The WTRU may determine the type of SRS sequence to map to the SRS resource based on preconfigured rule. For example, when MCS table type: 1 is configured for UL PUSCH transmission, the WTRU may map the first SRS sequence on the first SRS resource and the second SRS sequence on the second SRS resource. For example, when MCS table type: 2 is configured for UL PUSCH transmission, the WTRU may map the second SRS sequence on the first SRS resource and the first SRS sequence on the second SRS resource.

What is claimed is:

1. A wireless transmit/receive unit (WTRU) comprising:
a processor configured to:
receive configuration information, wherein the configuration information comprises an indication of a first Channel Quality Indicator (CQI) table associated with preconfigured modulations, an indication of a second CQI table associated with learned modulations;
determine first measurements associated with a plurality of reference signals (RSs) of a first type, wherein the first type of RSs is associated with the preconfigured modulations;
determine second measurements associated with a plurality of RSs of a second type, wherein the second type of RSs is associated with the learned modulations;
determine to use the second CQI table based on a comparison between the second measurements associated with the plurality of RSs of the second type with the first measurements associated with the plurality of RSs of the first type; and
send a report, wherein the report comprises CQI and an indication that the second CQI table type was used to determine the CQI.

2. The WTRU of claim 1, wherein the first measurements comprise a first signal-to-noise ratio (SNR) and the second measurements comprise a second SNR, and wherein the processor is configured to determine to use the second CQI table to determine the CQI based on the second SNR being greater than the first SNR.

3. The WTRU of claim 1, wherein the first measurements comprise a first Mean Square Error (MSE) and the second measurements comprise a second MSE, and wherein the processor is configured to determine to use the second CQI table to determine the CQI based on the second MSE being less than the first MSE.

4. The WTRU of claim 1, wherein the first measurements is associated with one or more of a first throughput, a first Block Error Ratio (BLER), or a first number of retransmissions, and the second measurements is associated with one or more of a second throughput, a second Block Error Ratio (BLER), or a second number of retransmissions.

5. The WTRU of claim 1, wherein the report comprises assistance information for fallback to the first CQI table type, wherein the assistance information comprises an SNR offset or a CQI index.

6. The WTRU of claim 1, wherein the configuration information further comprises an indication of a first Modulation and Coding Scheme (MCS) table associated with preconfigured modulations, an indication of a second MCS table associated with the learned modulations, and a symbol-to-bits de-mapper associated with the second MCS table; and
wherein the processor is configured to
receive Downlink Control Information (DCI) that provides a Physical Downlink Shared Channel Transmission (PDSCH) allocation;
receive a PDSCH transmission associated with the PDSCH allocation;
demodulate the PDSCH transmission using the symbol-to-bits de-mapper associated with the second MCS table; and
decode the PDSCH transmission based on the second MCS table.

7. The WTRU of claim 6, wherein the DCI indicates that the second MCS table should be used to demodulate the PDSCH allocation.

8. The WTRU of claim 6, wherein the processor is configured to determine to use the second CQI table instead of the first CQI table to determine the CQI when the second MCS table is signaled.

9. The WTRU of claim 1, wherein the configuration information further comprises CQI assistance information that provides a mapping of values between the first CQI table and the second CQI table.

10. The WTRU of claim 1, wherein the learned modulations are based on an artificial intelligence/machine learning (AI/ML) model, or wherein the learned modulations are characterized by a non-equal distance between constellations of each modulation order of the learned modulation orders; and
wherein the preconfigured modulation orders comprise one or more of Binary Phase-shift keying (BPSK), Quadrature Phase Shift Keying (QPSK), or 16-Quadrature amplitude modulation (QAM), or wherein the preconfigured modulation orders are characterized by an equidistance between constellations of each modulation order of the preconfigured modulation orders.

11. A method implemented by a wireless transmit/receive unit (WTRU), the method comprising:
receiving configuration information, wherein the configuration information comprises an indication of a first Channel Quality Indicator (CQI) table associated with preconfigured modulations, an indication of a second CQI table associated with learned modulations;
determining first measurements associated with a plurality of reference signals (RSs) of a first type, wherein the first type of RSs is associated with the preconfigured modulations;
determining second measurements associated with a plurality of RSs of a second type, wherein the second type of RSs is associated with the learned modulations;
determining to use the second CQI table based on a comparison between the second measurements associated with the plurality of RSs of the second type with the first measurements associated with the plurality of RSs of the first type; and
sending a report, wherein the report comprises CQI and an indication that the second CQI table type was used to determine the CQI.

12. The method of claim 1, wherein the first measurements comprise a first signal-to-noise ratio (SNR) and the second measurements comprise a second SNR, and wherein the method further comprises determining to use the second CQI table to determine the CQI based on the second SNR being greater than the first SNR.

13. The method of claim 1, wherein the first measurements comprise a first Mean Square Error (MSE) and the second measurements comprise a second MSE, and wherein the method further comprises determining to use the second CQI table to determine the CQI based on the second MSE being less than the first MSE.

14. The method of claim 1, wherein the first measurements is associated with one or more of a first throughput, a first Block Error Ratio (BLER), or a first number of retransmissions, and the second measurements is associated with one or more of a second throughput, a second Block Error Ratio (BLER), or a second number of retransmissions.

15. The method of claim 1, wherein the report comprises assistance information for fallback to the first CQI table type, wherein the assistance information comprises an SNR offset or a CQI index.

16. The method of claim 1, wherein the configuration information further comprises an indication of a first Modulation and Coding Scheme (MCS) table associated with preconfigured modulations, an indication of a second MCS table associated with the learned modulations, and a symbol-to-bits de-mapper associated with the second MCS table; and
wherein the method further comprises:
receiving Downlink Control Information (DCI) that provides a Physical Downlink Shared Channel Transmission (PDSCH) allocation;
receiving a PDSCH transmission associated with the PDSCH allocation;
demodulating the PDSCH transmission using the symbol-to-bits de-mapper associated with the second MCS table; and
decoding the PDSCH transmission based on the second MCS table.

17. The method of claim 6, wherein the DCI indicates that the second MCS table should be used to demodulate the PDSCH allocation.

18. The method of claim 6, wherein the method further comprises determining to use the second CQI table instead of the first CQI table to determine the CQI when the second MCS table is signaled.

19. The method of claim 1, wherein the configuration information further comprises CQI assistance information that provides a mapping of values between the first CQI table and the second CQI table.

20. The method of claim 1, wherein the learned modulations are based on an artificial intelligence/machine learning (AI/ML) model, or wherein the learned modulations are characterized by a non-equal distance between constellations of each modulation order of the learned modulation orders; and
wherein the preconfigured modulation orders comprise one or more of Binary Phase-shift keying (BPSK), Quadrature Phase Shift Keying (QPSK), or 16-Quadrature amplitude modulation (QAM), or wherein the preconfigured modulation orders are characterized by an equidistance between constellations of each modulation order of the preconfigured modulation orders.
